(19) United States
(12) Patent Application Publication
(10) Pub. No.: US 2014/0213328 A1
(43) Pub. Date: Jul. 31, 2014

(54) MOBILE DEVICE HOLDER FOR HANDS-FREE USE

(71) Applicant: Daryl E. Faulk, Park City, UT (US)

(72) Inventor: Daryl E. Faulk, Park City, UT (US)

(21) Appl. No.: 14/076,059

(22) Filed: Nov. 8, 2013

Related U.S. Application Data
(63) Continuation-in-part of application No. 13/410,082, filed on Mar. 1, 2012.

(51) Int. Cl. H04M 1/60; H04B 1/38

(52) U.S. Cl. CPC H04M 1/6075; H04B 1/3888
USPC 455/569.2

(57) ABSTRACT

The disclosure extends to an apparatus, system and method for providing a user with the ability to use a mobile device hands-free while performing other tasks. The disclosure further extends to an apparatus having a substantially rigid body with a pouch formed between an upper portion and a lower portion of the body for receiving a mobile device therein, and a channel formed within the body. The apparatus may utilize a band made from an elastic material that is located within the channel of the body and is freely slidable within the channel to retain and hold the mobile device within the pouch. The apparatus may also include a cover member that substantially covers the body and the band to thereby secure the band within the channel.

### CROSS-REFERENCE TO RELATED APPLICATIONS

This application is a continuation-in-part of co-pending U.S. patent application Ser. No. 13/410,082 filed Mar. 1, 2012, entitled “MOBILE DEVICE HOLDER FOR HANDS-FREE USE,” which is hereby incorporated by reference herein in its entirety, including but not limited to those portions that specifically appear hereinafter, the incorporation by reference being made with the following exception: In the event that any portion of the above-referenced application is inconsistent with this application, this application supersedes said portion of said above-referenced application.

### BACKGROUND

The disclosure described herein relates generally to a device for holding mobile devices, such that the mobile device can be used hands-free while performing tasks that require the use of hands such as, yard work, desk work and driving an automobile. The disclosure relates more particularly, but not entirely, to a device having a combination of structural plates that securely hold and retain a mobile device to thereby position and allow the mobile device to be used while operating and otherwise maintaining control of the automobile with both hands, which device may be attached securely to and removed from an automobile safety restraint or harness.

One of the most important tasks of daily life that is usually combined with making a phone call is driving an automobile. Automobiles have become an essential element in the way of life for much of the population of the world; in particular, the United States. More and more Americans and others around the world are spending a significant portion of their time traveling in an automobile for one reason or another. Mobile device usage, in particular cellular phone usage, is on a similar, if not more rapid, rate of increase. As of 2007, over 250 million Americans have and use cell phones regularly. That number is continuing to increase dramatically each year since then.

Being that cell phone usage and automobile ownership are such major parts of life, it is understandable that the two facets of life overlap. However, it is at the intersection of these two facets of life that a significant problem has developed in society, namely cell phone use while driving an automobile that leads to distracted driving. It will be appreciated that use of a handheld cellular or mobile phone while driving reduces awareness and attentiveness while driving, thus increasing the likelihood of an accident. It is reported that drivers distracted by their cell phones have caused nearly 1,000 vehicle accidents that resulted in fatalities. In addition, more than 400,000 accidents resulting in injuries are attributable to drivers distracted by their cellular phones.

To combat this problem, states have responded with legislation to restrict or eliminate handheld cellular phone usage while driving an automobile. At least seventeen states, including California and New York, have passed legislation either completely barring or otherwise limiting people from using handheld phones while driving and other states are considering such measures. This accounts for over 25% of the country's population. Approximately 28 states have a limitation in some form for handheld cellular phone use while driving.

To respond to such legislation and for the general promotion of driver safety, many companies have created and sold devices, which allow a user to use his mobile device hands-free, thus freeing both hands of a user to maintain control of the automobile.

While many of these devices do provide the user the ability to use his mobile device in a safe manner, the known devices are fraught with several disadvantages, which make them difficult for many users. For example, many such devices require the installation of equipment permanently attached to the automobile. Other devices may require an alteration to the automobile, which can only be done by a mechanic; such alterations can prove to be very expensive. Still other devices lack sufficient means to hold the mobile device secure, such devices may result in damage to the mobile device, or may not adequately hold the mobile device at all. Many of the existing devices are too far from the user and thus reduce their effectiveness to communicate with the third person. Additionally, such devices are cumbersome to handle and require a degree of attention from the user. Such an effect is contrary to the purpose of said devices to increase the attentiveness of the user.

Therefore, it would be beneficial to provide a hands-free device that did not require permanent attachment to the vehicle, would be relatively inexpensive, would securely and safely retain the mobile device, and could be easily installed and secured to an automobile safety restraint or harness. The disclosure is directed to achieve such objectives and other related objectives.

The features and advantages of the disclosure will be set forth in the description which follows, and in part will be apparent from the description, or may be learned by the practice of the disclosure without undue experimentation. The features and advantages of this disclosure may be realized and obtained by means of the instruments and combinations particularly pointed out in the appended claims.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIG. 1 is a perspective view of an implementation of the disclosure wherein one structural plate may rotate with respect to another structural plate according with the principles of this disclosure;

FIG. 2 is a side view of an implementation of the disclosure showing a mechanical closure, which may allow one structural plate to rotate with respect to another structural member;

FIG. 3 is a front view of an implementation of a mechanical closure for allowing a structural plate to rotate about another structural plate;

FIG. 4 is a perspective view of an implementation of the disclosure wherein a structural plate does not rotate with respect to another structural plate;

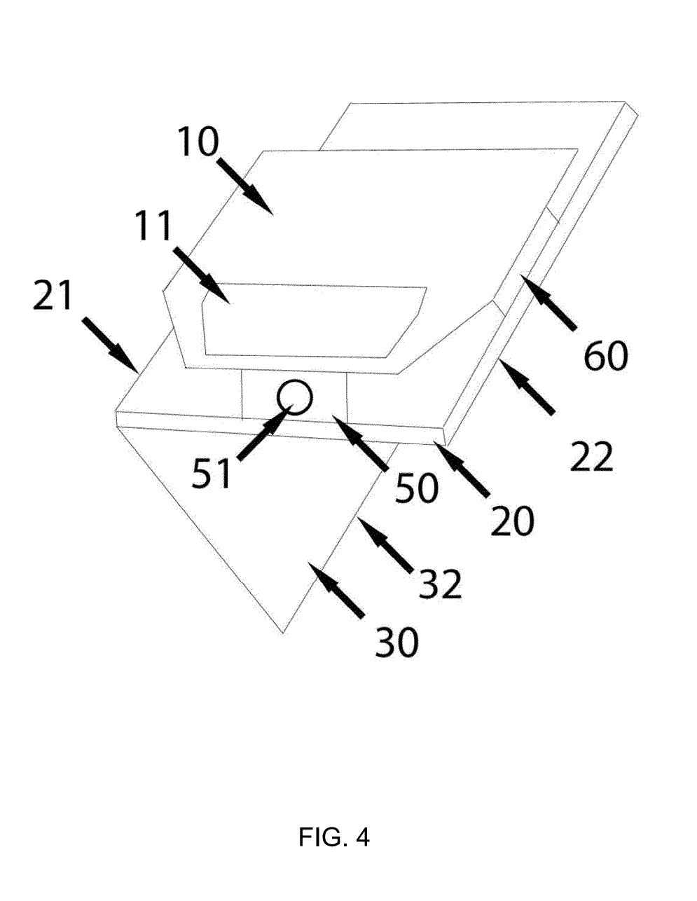

FIG. 5 is a perspective view of an implementation of the disclosure wherein a structural plate (e.g., top plate) is replaced with plastic side members to hold the mobile device;

FIG. 6 is a front view of an implementation of a hands-free apparatus for holding a mobile device made in accordance with the principles of the disclosure;

FIG. 7 is a back view of an implementation of a hands-free apparatus for holding a mobile device made in accordance with the principles of the disclosure;

FIG. 8 is a side view of an implementation of a hands-free apparatus for holding a mobile device made in accordance with the principles of the disclosure;

FIG. 9 is an opposite side view with respect to FIG. 8 of an implementation of a hands-free apparatus for holding a mobile device made in accordance with the principles of the disclosure;

FIG. 10 is a bottom view of an implementation of a hands-free apparatus for holding a mobile device made in accordance with the principles of the disclosure;

FIG. 11 is a back perspective view of an implementation of a hands-free apparatus for holding a mobile device made in accordance with the principles of the disclosure;

FIG. 12 is a front perspective view of an implementation of a hands-free apparatus for holding a mobile device made in accordance with the principles of the disclosure;

FIG. 13 is a side view and perspective view of components of an implementation of a hands-free apparatus for holding a mobile device made in accordance with the principles of the disclosure;

FIGS. 14A and 14B are perspective views of different implementations of a band used in a hands-free apparatus for holding a mobile device in accordance with the principles of the disclosure;

FIG. 15 is a perspective and side view of an implementation of a hands-free apparatus for holding a mobile device made in accordance with the principles of the disclosure;

FIG. 16, from left to right, is a back view, side view, and front view, respectively, of an implementation of a hands-free apparatus for holding a mobile device made in accordance with the principles of the disclosure;

FIG. 17 illustrates a rear view of a hands-free device in accordance with the principles of the disclosure;

FIG. 18 illustrates a rear view of a hands-free device showing dual complementary magnets in accordance with the principles of the disclosure; and

FIG. 19 illustrates a rear perspective view of a mobile phone in use within the hands-free device in accordance with the principles of the disclosure.

### DETAILED DESCRIPTION

For the purposes of promoting an understanding of the principles in accordance with the disclosure, reference will now be made to the implementations illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure.

It is to be understood that this disclosure is not limited to the particular configurations, process steps, and materials disclosed herein as such configurations, process steps, and materials may vary somewhat. It is also to be understood that the terminology employed herein is used for the purpose of describing particular implementations only and is not intended to be limiting since the scope of the disclosure will be limited only by the appended claims, if any, and equivalents thereof.

In describing and claiming the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “complementary magnets” is intended to mean magnets that are arranged so as to be attractive rather than repulsive to corresponding magnets.

It will be noted in the figures and detailed description contained herein that like reference numerals refer to like elements in the disclosure. The figures illustrate implementations of a hands-free apparatus for holding a mobile device. An implementation of the device of the disclosure may comprise the following elements a first plate 10, a second plate 20, a third plate 30, a fourth plate 40, a bottom joining material 50, side joining material 60, a male component of the rotational mechanical closure 70, a female component of a rotational mechanical closure 80, and bottom and side securing members 90. Other implementations of a hands-free apparatus for holding a mobile device for use in an automobile or other circumstances are also disclosed.

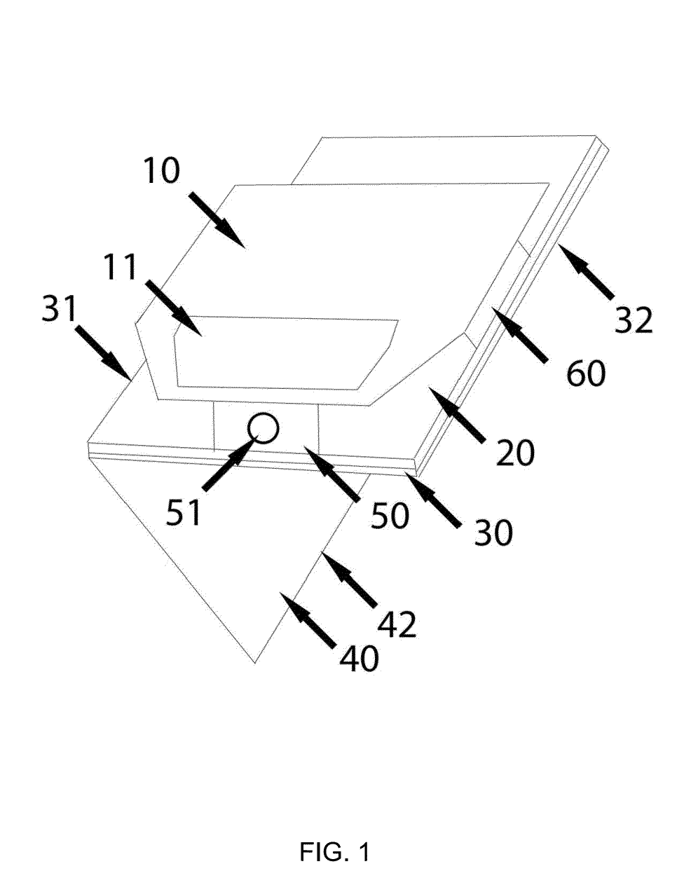

Referring to FIG. 1, there is depicted an implementation of a hands-free apparatus for holding a mobile device, such as a mobile telephone or other mobile device for communicating with a third party, in accordance with the principles of the disclosure. A device of the disclosure may comprise a plurality of structural plates. In the disclosure, a first plate 10 and a second plate 20 may be configured such that they form a pouch wherein a mobile device may be located. This pouch may also comprise a side joining material 60 that may be connected to an edge of the first plate 10 that extends towards and joins the second plate 20 along a corresponding edge. This pouch may also comprise a bottom joining material 50 that may be connected to an edge of the first plate 10 and extends towards the joins the second plate 20 along a corresponding edge.

It will be appreciated that the purpose of this disclosure is to construct an apparatus that will securely hold a mobile device in a position that facilities a user's ability to control an automobile with both hands while simultaneously using the mobile device. Therefore, side joining material 60, and bottom joining material 50 may be comprised of a flexible material that when stretched exerts a force against the mobile device to retain the mobile device in the pouch created between the first plate 10 and the second plate 20. Moreover, an implementation of the side joining material 60, and the bottom joining material 50, may be comprised of any material that may securely hold the mobile device in a fixed location.

An implementation of the disclosure may comprise side joining material 60 and bottom joining material 50 that extend the length and width of the first plate 10. It will be appreciated that the purpose of this disclosure is to allow a user to use a hands free mobile device hands free. It will be appreciated to fully accomplish the hands free goal, the mobile device, such as a mobile telephone, may be used in speaker phone mode to allow the user to hear audible communications from the third party without the mobile device being placed near a user's ear. In accordance with this purpose, a device of this disclosure may comprise a mechanism wherein the speaker of the mobile device may be accessible. Accordingly, a device of the disclosure may comprise an aperture 51 at some point along the bottom joining material. Similarly, a device of the disclosure may comprise an aperture 11 in the first plate 10. To protect the mobile device either aperture may be covered by a material to protect the mobile device. Both the aperture in the bottom joining material 51, and the aperture in the first plate 11 of these apertures may be covered by a mesh material to protect and secure the mobile device in the disclosure; any other material that would protect the mobile device and allow it to be used may be cover the apertures as well.

A device of the disclosure relates to circumstances where a driver of an automobile requires the use of a mobile device. Accordingly, an implementation of the disclosure may further comprise a manner for attaching a device of the disclosure to a safety restraint or harness of an automobile. Such an attachment may be achieved by use of a third plate 30 and a fourth plate 40; said plates having two configurations. The first configuration may comprise the third plate 30 and the fourth plate 40 held such that a gap exists between them, wherein the third plate 30 and the fourth plate 40 may be positioned on either side of an automobile safety restraint. The second configuration may comprise the third plate 30 and the fourth plate 40 in positions substantially parallel to one another around an automobile safety restraint or harness. An implementation of the disclosure may comprise joining the third plate 30 and fourth plate 40 such that they can be secured and held to the safety restraint or harness in a single step. Accordingly, the third plate 30 and the fourth plate 40 may be joined along a corresponding edge 31 of the two plates wherein the third plate 30 may pivot relative to the fourth plate 40. This may be accomplished by a seamed pivot hinge along the edge 31, a mechanical hinge placed at some point along the edge 31, or any other device that allows the third plate 30 to pivot about the fourth plate 40.

To facilitate the hands-free use of the mobile device a mechanical closure may be utilized to retain the third plate 30 and the fourth plate 40 in a closed position wherein they are in a position substantially parallel to one another, and secured against an automobile safety restraint or harness. This mechanical closure may comprise a variety of different mechanisms. An implementation of the disclosure may comprise corresponding magnetic strips or buttons placed on the surface of the third plate 30 and the corresponding surface of the fourth plate 40. An implementation may comprise a hinge spring along the joined edge 31 of the third plate 30 and the fourth plate 40. This spring hinge may have a natural position wherein the third plate 30 and the fourth plate 40 are held in the closed position. A device of the disclosure may comprise the use of corresponding Velcro™ patches on the surface of the third plate 30 and the corresponding surface of the fourth plate 40. An implementation may utilize a locking mechanical enclosure located on the non-joined edge 32 of the third plate 30, and the non-joined edge 42 of the fourth plate 40. An implementation of the disclosure may comprise any mechanism that may temporarily lock the third plate 30 into a position that is substantially parallel to the fourth plate 40.

All the plates in an implementation of the disclosure may be constructed out of any material that would allow for a mobile device to be adequately held in location and would offer structural stability to the apparatus of the disclosure. In accordance the plates may be constructed of a rigid plastic material or any other material that adds rigidity to the structure. The plates may similarly be configured to any size and shape that allows for the functionality of the apparatus according with the principles of this disclosure. An implementation of the disclosure may comprise a first plate 10 that is substantially similar in size and shape to the second plate 20.

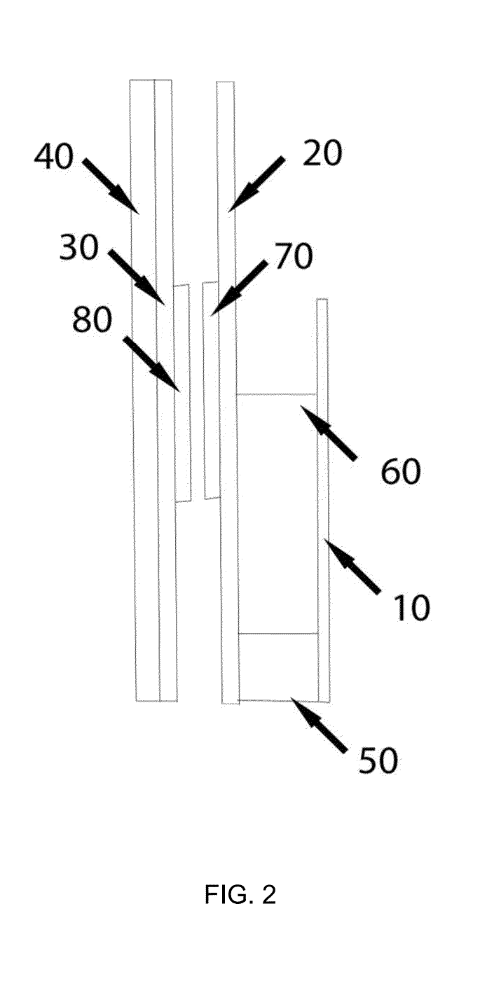

Referring now to FIGS. 1 through 3, which illustrate a device of the disclosure according to the principles of this disclosure wherein the first plate 10 and second plate 20 may rotate with respect to the third plate 30 and the fourth plate 40. It is to be appreciated that it is common for automobile safety restraints to be positioned diagonally to a user. Accordingly, an implementation of the disclosure may comprise a mechanical device that allows rotation of a device of the disclosure to a position that is in-line with the user to facilitate a more efficient mode of use. Such an implementation may comprise a snap ring configuration wherein a male portion of the snap ring 70 is rigidly connected to the second plate 20 and a female portion of the snap ring 80 is rigidly connected to the third plate 30. When the male portion 70 is connected to the female portion 80 they may allow the first plate 10 and the second plate 20 to rotate with respect to the safety restraint, the third plate 30 and the fourth plate 40. A device of the disclosure may also comprise a ball and socket joint wherein the ball is rigidly attached to either the second plate 20 or the third plate 30 and the socket is rigidly attached to the corresponding plate. An implementation of the disclosure may provide that the male portion 70 and the female portion 80 of the locking mechanism, or the ball and socket portions may separate from one another. In this configuration the third plate 30 and the fourth plate 40 may remain secured to the safety restraint while the second plate 20 and the first plate 10 may be separated for use or storage. A device of this disclosure may comprise any mechanical device that may allow the first plate 10 and the second plate 20 to rotate about the third plate 30, the fourth plate 40, and the safety restraint. Such a device may be made of any material that would support the weight of the mobile device and corresponding plates. Accordingly, the male portion 70, the female portion 80, and the ball and socket joints may be constructed of an injected molded plastic material.

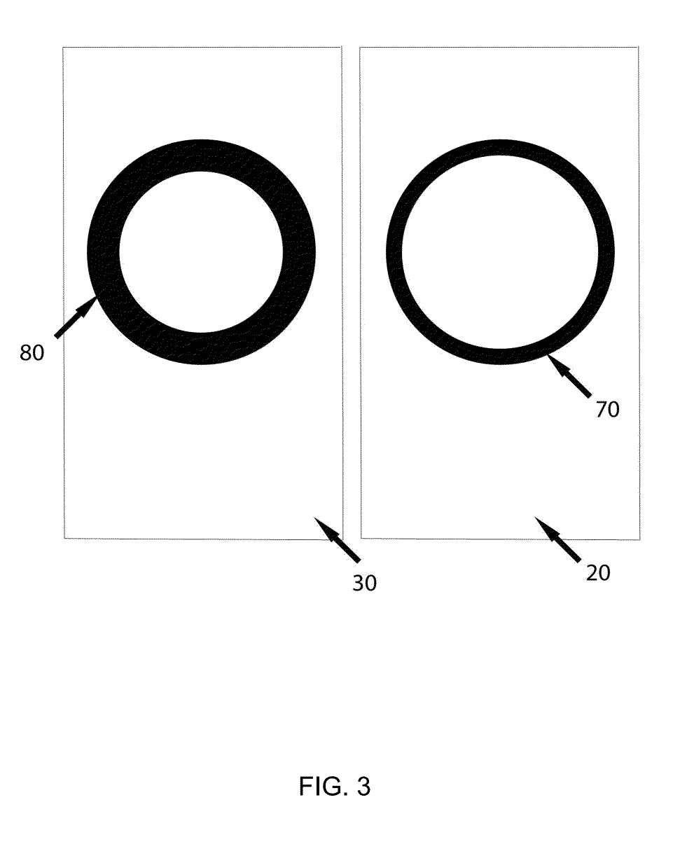

Referring now to FIG. 3, which illustrates an implementation in accordance with the principles of this disclosure, wherein the apparatus may not rotate from a position in-line with the automobile safety restraint to a position in-line with the user. This implementation may comprise a first plate 10 and a second plate 20 aligned and connected by a side joining material 60 and a bottom joining material 50 to form a pouch wherein a mobile device may be located.

An implementation of the disclosure may further comprise a manner for attaching the disclosure to a safety restraint or harness of an automobile. Such an attachment may be achieved by use of a second plate 20 and a third plate 30; said plates having two configurations. The first configuration may comprise the second plate 20 and the third plate 30 held such that a gap may exist between them wherein a mobile device may rest and wherein the second plate 20 and the third plate 30 may be positioned on either side of an automobile safety restraint. The second configuration may comprise the second plate 20 and the third plate 30 in positions substantially parallel to one another around an automobile safety restraint or harness.

An implementation of the disclosure may comprise joining the second plate 20 and third plate 30 such that they can be secured and held to the safety restraint or harness in a single step. Accordingly, the second plate 20 and the third plate 30 may be joined along a corresponding edge 21 of the two plates wherein the second plate 20 may pivot relative to the third plate 30. This may be accomplished by a seamed pivot hinge along the edge 21, a mechanical hinge placed at some point along the edge 21, or any other device that allows the second plate 20 to pivot about the third plate 30.

To facilitate the hands-free use of the mobile device a mechanical closure may be utilized to retain the second plate 20 and the third plate 30 in a closed position wherein they are in a position substantially parallel to one another, and secured against an automobile safety restraint or harness. This mechanical closure may comprise a variety of different mechanisms. An implementation of the disclosure may comprise corresponding magnetic strips or buttons placed on the surface of the second plate 20 and the corresponding surface of the third plate 30. An implementation may comprise a hinge spring along the joined edge 21 of the second plate 20 and the third plate 30. This spring hinge may have a natural position wherein the second plate 20 and the third plate 30 are held in the closed position. A device of the disclosure may comprise the use of corresponding Velcro™ patches on the surface of the second plate 20 and the corresponding surface of the third plate 30. An implementation may utilize a locking mechanical enclosure located on the non-joined edge 22 of the second plate 20, and the non-joined edge 32 of the third plate 30. An implementation of the disclosure may comprise any mechanism that may temporarily lock the second plate 20 into a position that is substantially parallel to the third plate 30.

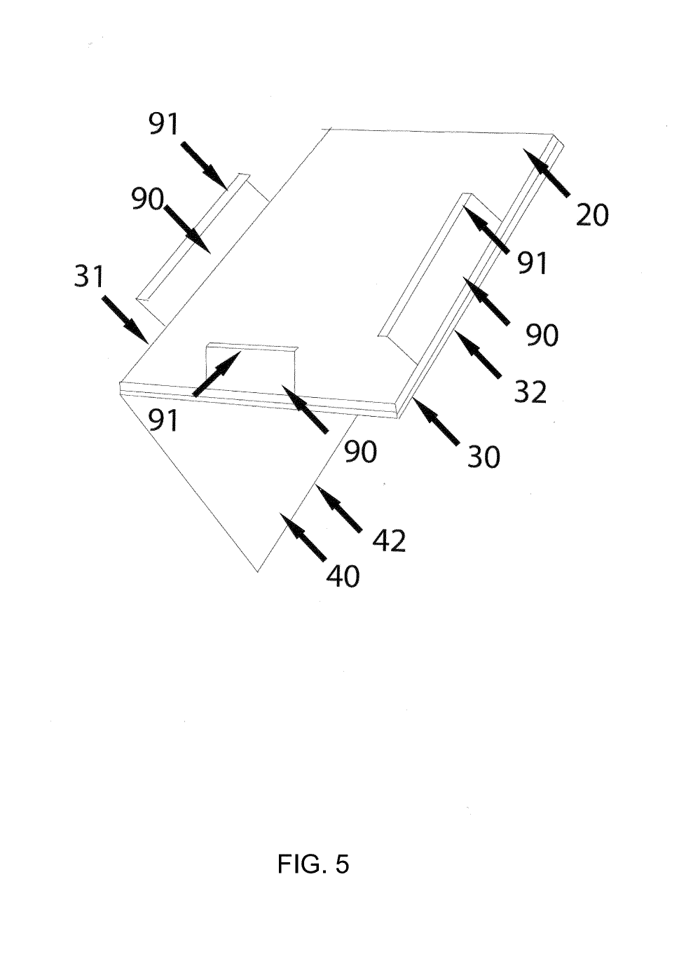

Referring now to FIG. 5, which illustrates an implementation in accordance with the disclosure, the first plate 10 may be replaced with rigid securing members 90. An implementation may include securing members 90 positioned on and joined to both sides and the bottom of the second plate 20. These securing members 90 may extend orthogonally from the surface of the second plate 20. Each of these securing members 90 may comprise a plastic lip 91 that would serve to hold the mobile device in a position substantially flush to the second plate 20. These securing members may be constructed out of a plastic material or any other material that would hold the mobile device in place.

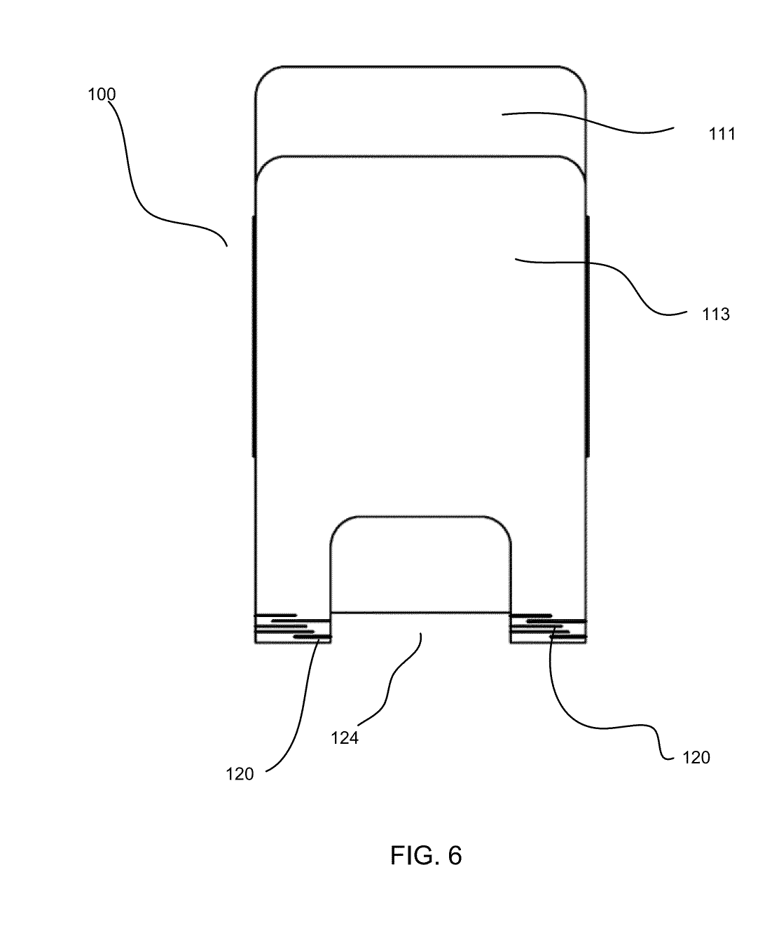

Referring now to FIGS. 6 through 12, wherein an implementation of a hands-free apparatus 100 for holding a mobile device is illustrated. The apparatus may comprise a pouch 102 that may be configured for receiving a mobile device therein, such as a mobile telephone or other mobile device for communicating with a third party. The apparatus 100 may also comprise a plurality of structural members 110. It will be appreciated that the structural members 110 may comprise a first plate 111 and a second plate 112 of predetermined size, shape and material.

The pouch 102 may be formed, at least in part, by the first plate 111. The pouch 102 may further comprise a third plate 113, wherein the first plate 111 and the third plate 113 are joined at one end by a plurality of legs 120. The pouch 102 may further comprise a plurality of joining members 122 connecting the first plate 111 to the third plate 113 at the lateral edges of the pouch 102. An aperture 124 may be formed between the plurality of legs 120 of the pouch 102, wherein the microphone, speaker or other communication buttons or accessories of the mobile device may be readily accessible by a user.

The apparatus 100 may further comprise a first joint 130 formed between the first plate 111 and the second plate 112, wherein said first joint 130 may connect the first plate 111 to the second plate 112, such that the second plate 112 may be rotated with respect to the first plate 111 about a single axis. The apparatus 100 may also comprise a first mechanical closure 132 that may be attached to the second plate 112. The first mechanical closure 132 may comprise a structural flap 134 and a foldable joint 136 for attaching the second plate 112 to an object, such as a safety restraint in a vehicle, to thereby position the pouch 102 for receiving the mobile device relative to a user such that the mobile device is useable in a hands-free mode. It will be appreciated that the foldable joint 136 may permit the structural flap 134 to move and be oriented into an open and closed position, such that said structural flap 134 is moveable from the open position into the closed position in a single step. The structural flap 134 may be oriented in a substantially parallel position with respect to the second plate 112 when the structural flap 134 is in the closed position and may comprise at least one magnet, such as a magnetic strip or button or a plurality of magnets, which may be held in place by adhesive or the material covering the apparatus 100, to retain the structural flap 134 in a closed position.

FIG. 6 illustrates a front view of an implementation of a hands-free apparatus 100 for holding a mobile device made in accordance with the principles of the disclosure. As can be seen in the figure, a pouch 102 is formed for holding a mobile device that is connected to a first 111 plate as a substantially rigid body that provides structure for the hands free-apparatus.

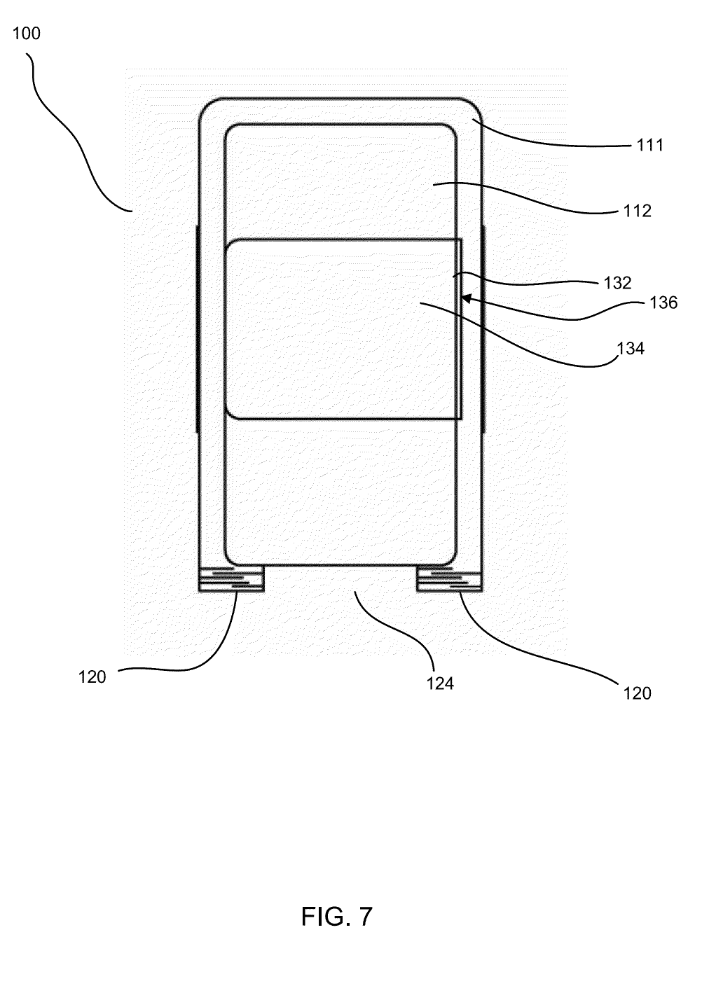

FIG. 7 illustrates a back view of an implementation of a hands-free apparatus for holding a mobile device made in accordance with the principles of the disclosure. As can be seen in the figure, the backside of the first plate 111 from FIG. 6 is illustrated as being connected to additional structures. One additional structure is a second plate 112 jointly connected to said first plate 111, and wherein said second plate 112 is attached to a flap 134 having a mechanical closure 132 thereon. Additionally, the second plate 112 and said mechanical structure 132 may be jointly connected by a foldable joint 136.

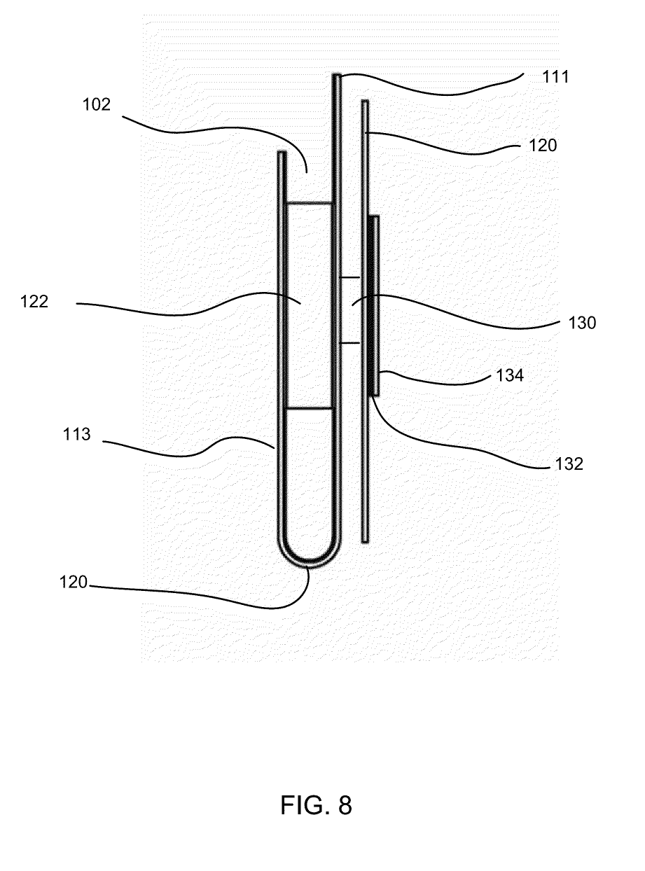

FIG. 8 illustrates a side view of an implementation of a hands-free apparatus for holding a mobile device made in accordance with the principles of the disclosure. As can be seen in the figure, the pouch portion 102 comprising the first plate 111 may be configured for holding a mobile device. Additionally, the backside of the first plate 111 from FIG. 6 is illustrated as being connected to additional structures. One additional structure is a second plate 112 jointly connected to said first plate 111, and wherein said second plate 112 is attached to a flap 134 having a mechanical closure 132 thereon. Additionally, the second plate and said mechanical structure 132 may be jointly connected by a foldable joint 136.

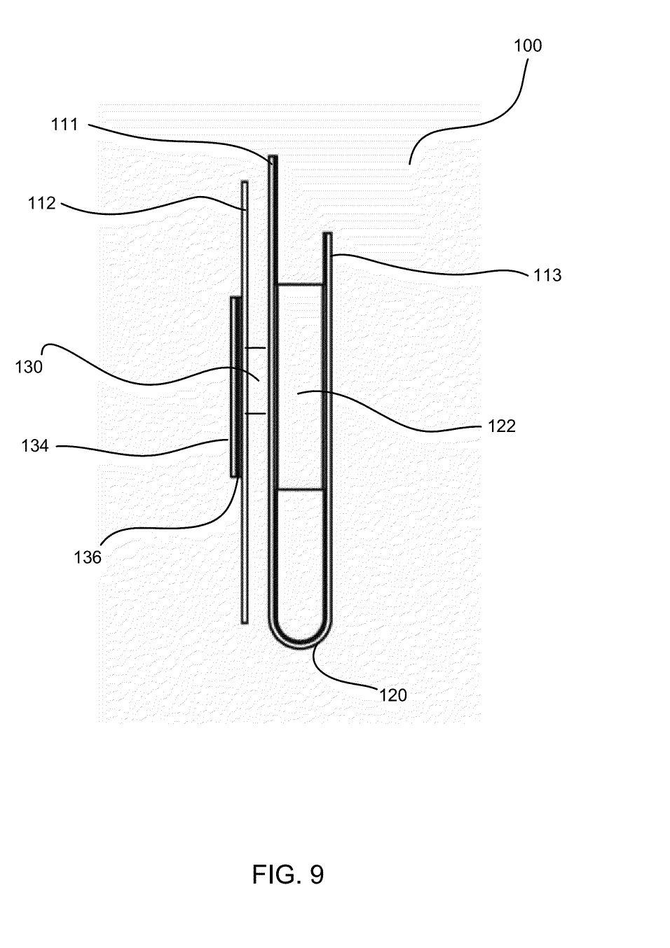

FIG. 9 illustrates a side view of an implementation of a hands-free apparatus for holding a mobile device made in accordance with the principles of the disclosure. As can be seen in the figure, the pouch portion 102 comprising the first plate 111 may be configured for holding a mobile device. Additionally, the backside of the first plate 111 from FIG. 6 is illustrated as being connected to additional structures. One additional structure is a second plate 112 jointly connected to said first plate 111, and wherein said second plate 112 is attached to a flap 134 having a mechanical closure 132 thereon. Additionally, the second plate 112 and said mechanical structure 132 may be jointly connected by a foldable joint 136.

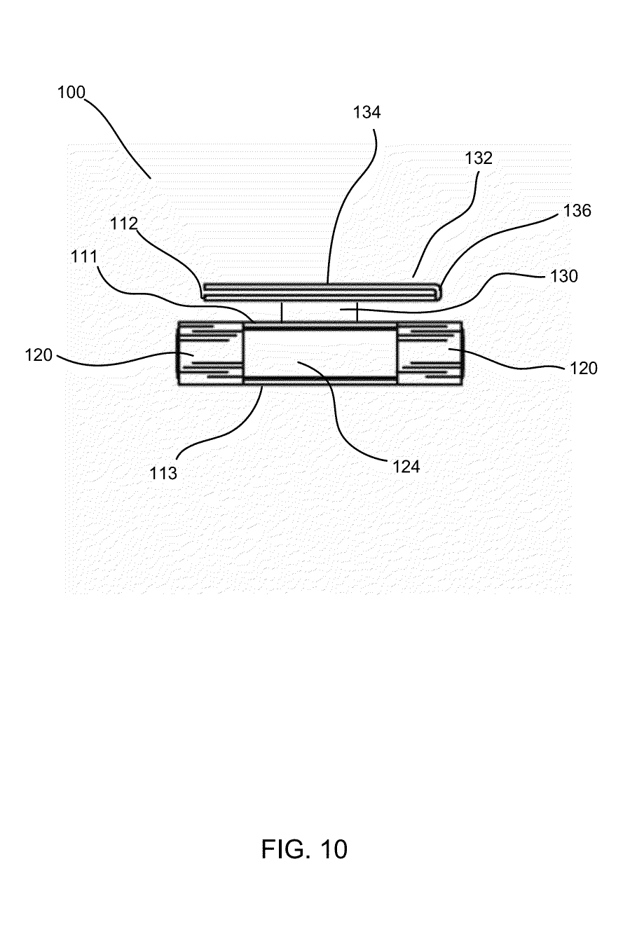

FIG. 10 is a bottom view of an implementation of a hands-free apparatus for holding a mobile device that provides a pivoting feature 130 made in accordance with the principles of the disclosure. As can be seen in the figure a pouch portion 102 can be pivotably connected to a either or both of the second plate 112 and mechanical closure 132 allowing the pouch portion 102 to pivot relative to the second plate 112 and mechanical closure 132.

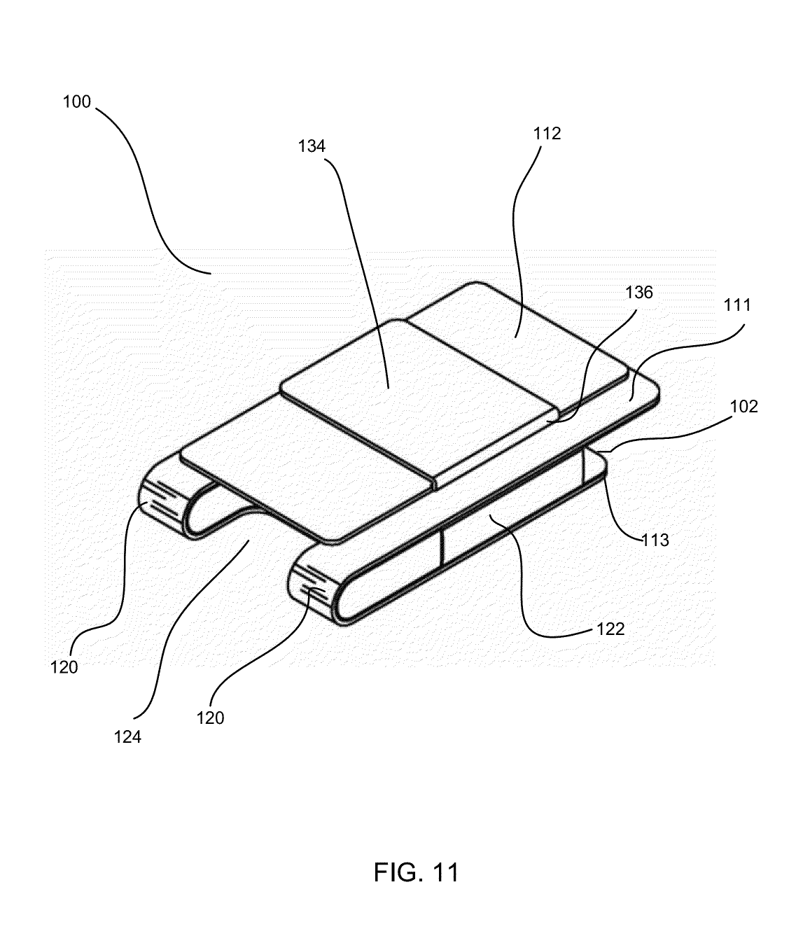

FIG. 11 illustrates a back perspective view of an implementation of a hands-free apparatus for holding a mobile device having a pivot 130 that is made in accordance with the principles of the disclosure. As can be seen in the figure, a pivot 130 may be employed to join the pouch portion 102 to either or both of the second plate 112 and the mechanical closure 132.

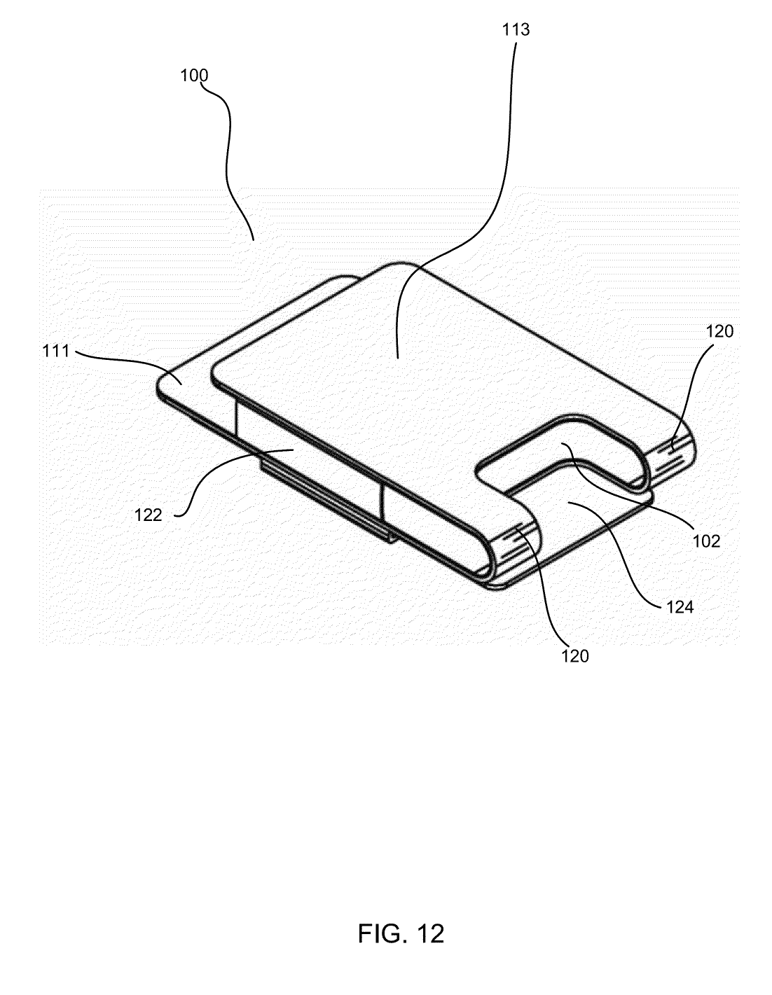

FIG. 12 is a front perspective view of an implementation of a hands-free apparatus for holding a mobile device having a pivot 130 made in accordance with the principles of the disclosure. As can be seen in the figure, a pivot 130 may be employed to join the pouch portion 102 to either or both of the second plate 112 and the mechanical closure 132.

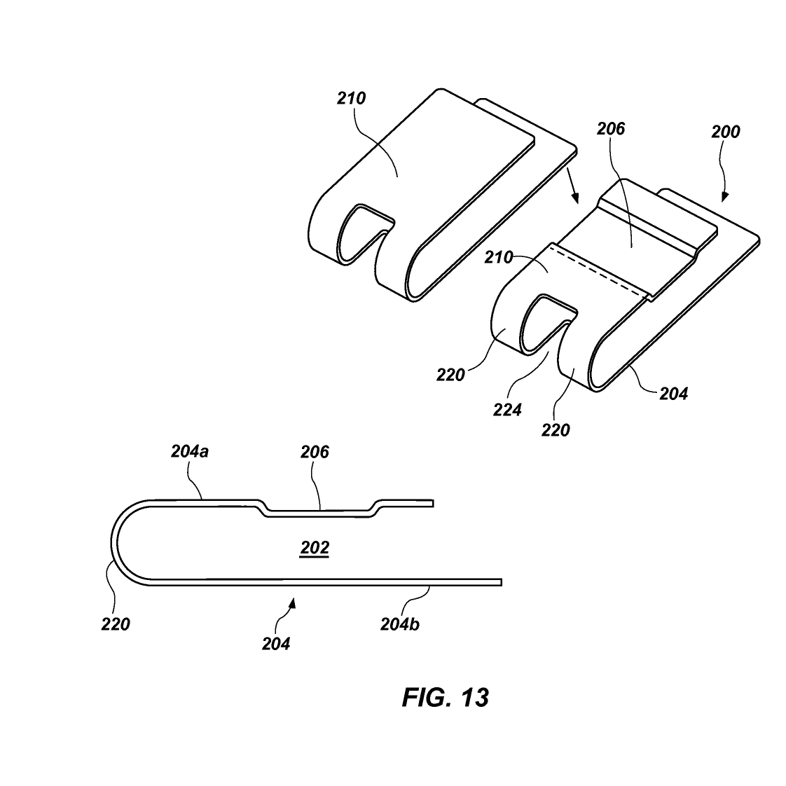

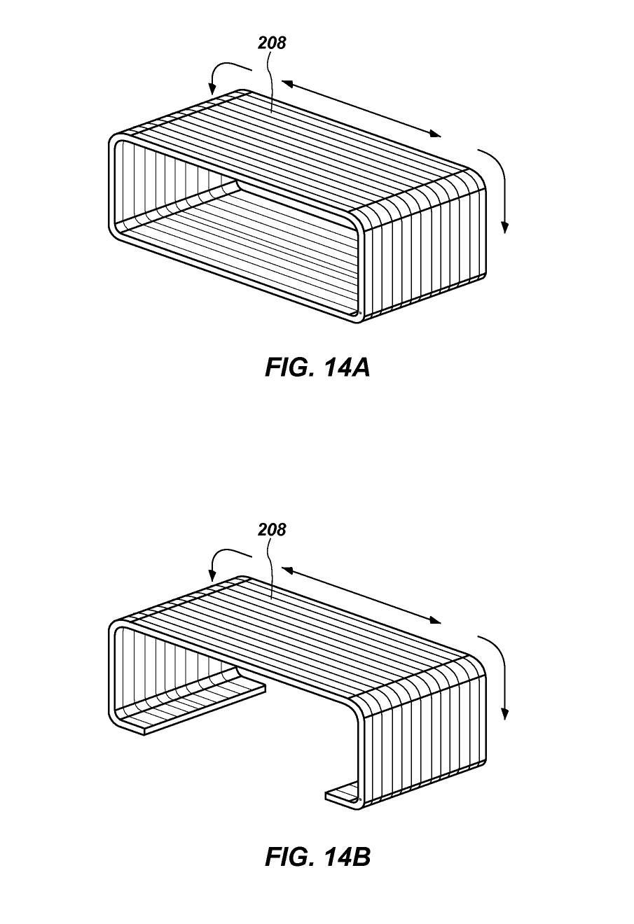

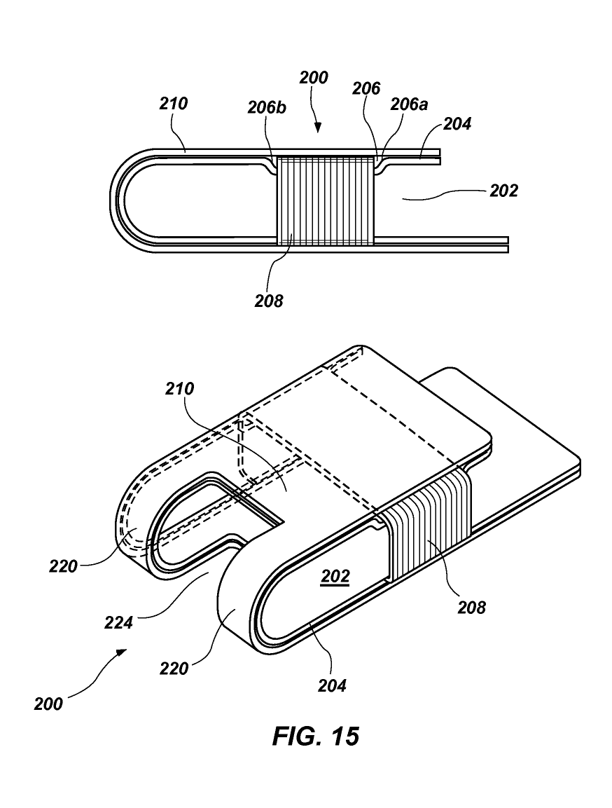

Referring now to the drawings illustrated in FIGS. 13-15, there is illustrated an implementation of a hands-free apparatus 200 for holding and securing a mobile device, such as a mobile phone, in accordance with the principles of the disclosure. As can be seen in FIG. 13, the apparatus 200 may generally comprise a body 204 and a cover 210. The body 204 is illustrated in the drawing located on the left of the page. The body 204 may be a substantially rigid body that may comprise a top portion 204a, a bottom portion 204b, a channel, slot or groove 206 for receiving a band 208 therein (illustrated best in FIGS. 14 and 15) that may be formed in the top portion 204a, and a plurality of legs 220. It will be appreciated that while the body 204 may be substantially rigid to provide structure and support to the apparatus 200, the body 204 may not be so rigid that it does not comprise at least some elastic properties as noted more fully below.

A pouch 202 may be formed between the top portion 204a and the bottom portion 204b of the body 204 for holding the mobile device therein. An aperture 224 may be formed between the plurality of legs 220, wherein a microphone, speaker or other communication buttons or accessories of the mobile device may be readily accessible by a user. The plurality of legs 220 may be substantially rigid, yet comprise some elastic properties so that the mobile phone or other mobile device is not inadvertently damaged by the apparatus 200. The elasticity also provides for a more comfortable, useable device for a user.

The cover 210 (illustrated best by the drawing at the top of the page in FIG. 13) may be comprised of various materials, including fabric, plastic or other material for covering and protecting the substantially rigid body 204. The cover 210 may be connected, attached or adhered to the body 204 of the apparatus 200 (illustrated best by the dashed lines and arrows in the drawing on the right side of the page in FIG. 13) using various techniques and methods, including sewing, stitching, gluing, epoxying or otherwise connecting or attaching techniques and methods suitable for the intended purpose.

Referring specifically to FIGS. 14A and 14B, wherein implementations of the band 208 are illustrated. It will be appreciated that the band 208 may be made from an elastic material and may exhibit properties of elasticity. The band 208 may be placed in tension when a mobile device is located within the pouch 202. The band 208 may also provide compression to the mobile device, thereby holding or grasping the mobile device in place within the pouch 202. It will be appreciated that the elasticity of the band 208 should be sufficient to compress, hold and grasp various sized mobile devices.

In an implementation, the band 208 may be movable or slidable within the channel, slot or groove 206 of the body 204. The movement or sliding of the band 208 within the channel, slot or groove 206 may assist in maintaining tension and compression with various size mobile devices. As illustrated best in FIG. 15, the band 208 may be free to move or slide within the channel 206. To keep the band 208 from moving outside of or to maintain the band 208 within the channel 206, the body 204 may be provided with a pair of upstanding walls 206a and 206b. The location and placement of the walls 206a and 206b may define the shape and size of the channel 206. It will be appreciated that the size and shape of the channel 206 may correspond with the size and shape of the band 204 in order to keep the band from binding or otherwise losing some of its elastic properties.

In an implementation, the band 208 may be made of one-piece construction, similar to a rubber band (illustrated best in FIG. 14A). In an implementation, the band 208 may be made of one-piece construction, but the band has two ends that may be sewn, glued or otherwise attached to the body 204 (illustrated best in FIG. 14B).

The apparatus 200 may further comprise a mechanical closure 225 on the back side of the apparatus 200. The mechanical closure 225 may be a flap or comprise a structural flap 234 and a foldable joint 236 for attaching the apparatus 200 to an object, such as a safety restraint in a vehicle, to thereby position the pouch 202 for receiving the mobile device relative to a user such that the mobile device is useable in a hands-free mode. It will be appreciated that the foldable joint 236 may permit the structural flap 234 to move and be oriented into an open and closed position, such that said structural flap 234 is moveable from the open position into the closed position in a single step. The structural flap 234 may be oriented in various ways depending upon where the most desirable position of the mobile device is when attached to an object such as a safety restraint or belt. For example, the flap 234 may be oriented in a diagonal position or a substantially parallel position with respect to the back side of the apparatus 200 when the structural flap 134 is in the closed position. Further, the flap 234 may comprise at least one magnet, such as a magnetic strip or button or a plurality of magnets, which may be held in place by adhesive or the cover 210 of the apparatus 200, to retain the structural flap 234 in a closed position. It will be appreciated that other mechanisms for maintaining the flap 234 in a closed position may also be utilized by the disclosure.

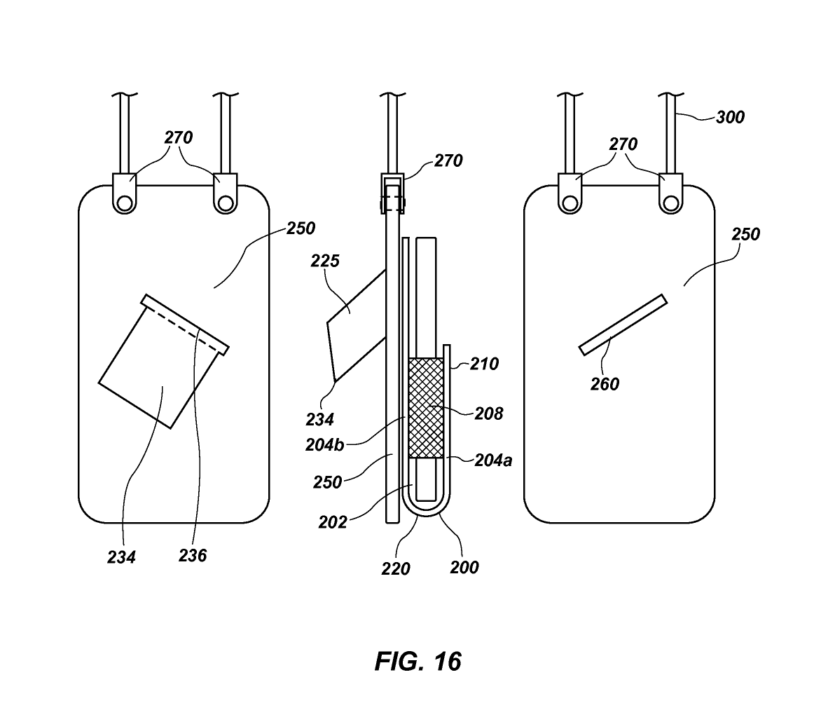

FIG. 16 illustrates a back view, a side view, and a front view, from left to right respectively, of an implementation of a hands-free apparatus for holding a mobile device in accordance with the principles of the disclosure. In an implementation, the hands-free device comprises the apparatus 200 described above in connection with FIGS. 13-15, and may further comprise a substantially rigid plate or generally flat structure 250. The structure 250 may be used for hanging around a user's neck or support, such as a pole or anchor, such that the mobile device may be used on the go or on the fly. To attach or connect the apparatus 200 to the structure, the structure 250 may comprise a slit or opening 260 therethrough. The slit or opening 260 may be used to receive the flap 234 or tongue for connecting the apparatus 200 to the structure 250 to form a complete device. In other words, the device may be modular and the different components, namely the apparatus 200 and the structure 250, may be used together or separately without departing from the scope of the disclosure.

In an implementation, the structure 250 may also comprise one or more connectors 270 for receiving a lanyard or other tethering device 300. The connectors may be located at a top portion 275 of the structure 250 and may be used connect and hang the structure 250 from the lanyard or other tethering device for the convenience of a user. The connectors 270 may be used to hang the apparatus 200 and structure 250 from the lanyard or other tethering device for the convenience of the user, for example, when a phone call has required the user to leave the vehicle or when it may be otherwise advantageous to have a user's hands free, such as while working.

In accordance with the features and combinations described and illustrated herein, a method for temporarily securing a mobile device to a vehicle safety restraint may comprise:

providing a first and second plate joined and configured to receive a mobile device, a third plate being joined along its edge to a corresponding edge of the second plate such that the second plate may rotate about a single axis with respect to the third plate, and a mechanical closure which retains the second plate in a position substantially parallel to the third plate;

positioning the second plate and the third plate such that they are not positioned substantially parallel to one another;

positioning the second plate and the third plate on either side of a vehicle safety restraint;

rotating the second plate such that it is substantially parallel to the third plate;

engaging the mechanical closure to retain the second plate in a position substantially parallel to the third plate; and

inserting mobile device between the first plate and the second plate.

In accordance with the features and combinations described and illustrated herein, another implementation of a method for temporarily securing a mobile device to a vehicle safety restraint may comprise:

providing a first and second plate joined and configured to receive a mobile device, a third plate being joined to the second plate such that the second plate may rotate about a fixed point of the third plate, a fourth plate being joined along its edge to a corresponding edge of the third plate such that the third plate may rotate about a single axis with respect to the fourth plate, and a mechanical closure which retains the third plate in a position substantially parallel to the fourth plate;

positioning the third plate and the fourth plate such that they are not positioned substantially parallel to one another;

positioning the third plate and the fourth plate on either side of a vehicle safety restraint;

rotating the third plate such that it is substantially parallel to the fourth plate;

engaging the mechanical closure to retain the third plate in a position substantially parallel to the fourth plate;

inserting mobile device between the first plate and the second plate; and

rotating the second plate wherein it may allow for communication with a third party.

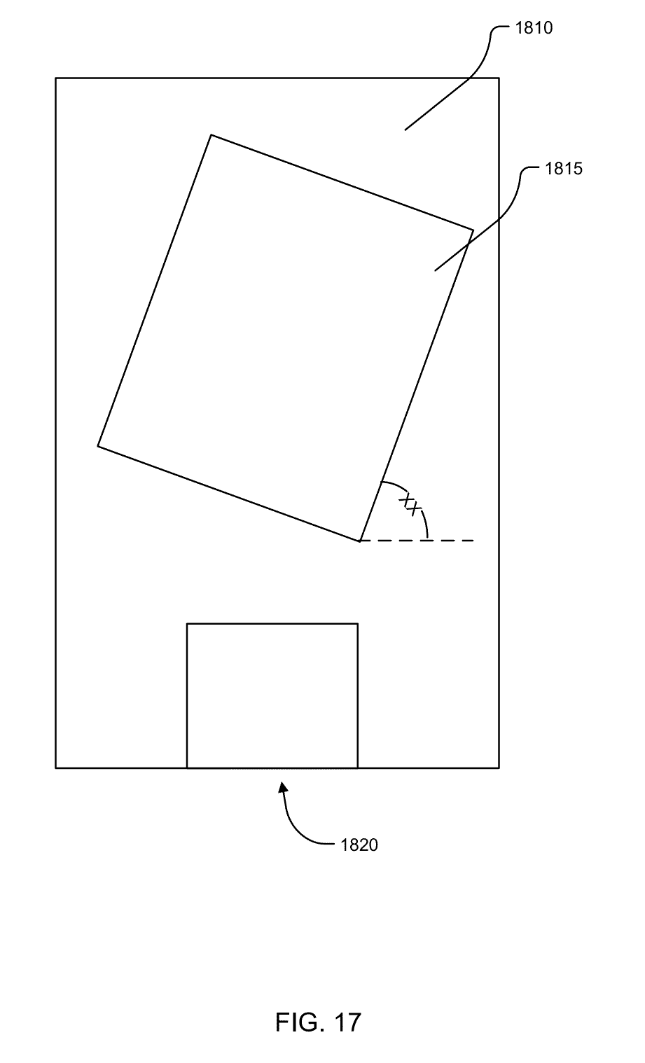

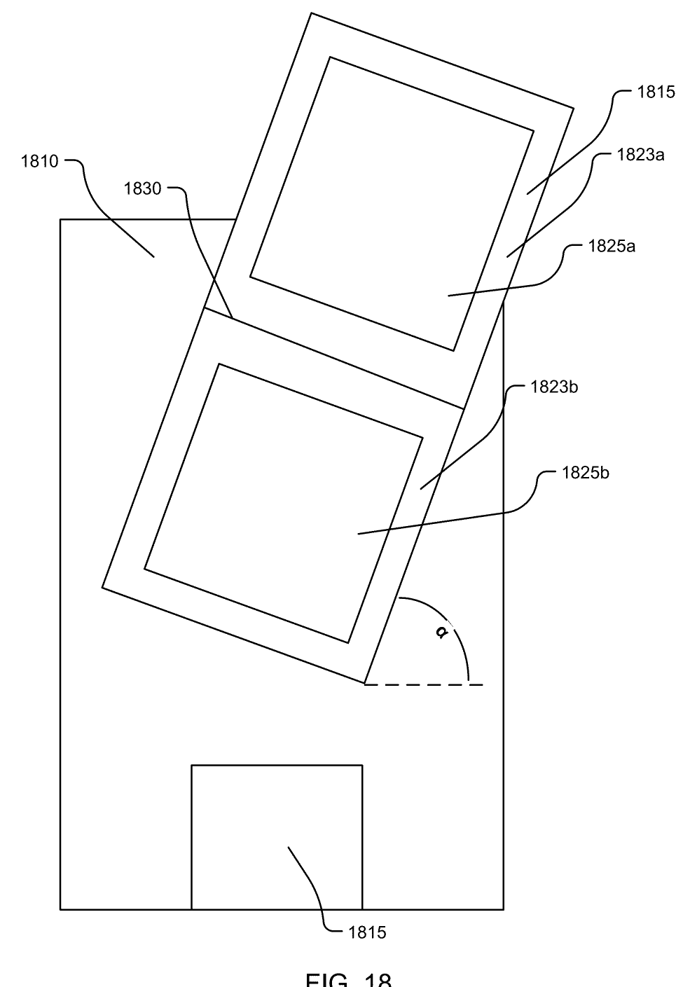

Illustrated in FIG. 17 and FIG. 18 is an implementation of a hands-free electronics holder for holding an electronic device in a usable position while performing tasks requiring the use of hands. The implementation may comprise a substantially rigid body 1810 comprising a first portion and a second portion, wherein the first portion may be configured to interface with the electronic device portion and wherein the second portion is configured to also interface with a second electronic device portion. The body 1810 may be made of any substantially rigid material such as, for example, paperboard or plastic board or any other substantially rigid material without departing from the scope of the disclosure. For example, about 1.6 mm (or about 0.629 inch) paperboard may be used or about 0.5 mm (or about 0.196 inch) plastic board may be used. The implementation may further comprise an opening 1820 for allowing access to and use of inputs/outputs of an electronic device. It should be understood that the opening 1820 may be located anywhere about the holder such that devices having various configurations of inputs and outputs can be accommodated.

In the implementation, a channel (206 of FIG. 13) is formed within a portion of the body for accommodating a band (206 of FIG. 15) made from an elastic material, which band is to be located within the channel of the body. The channel may additionally allow for the elastic band to slide freely therein allowing the holder to be biased in different configurations. In an implementation, the band may be secured at one or more ends, such that the band does not move freely within the channel. In an implementation, the band may be about 2 inches wide and have approximately 100% extension, or may have about 80% to about 120% extension. In an implementation, the about 2 inch wide elastic band may be about 10.6 cm long (or 4.18 inches) and may be secured permanently to the body 1810 at opposing ends.

Additionally, the implementation may comprise an attachment flap 1815 disposed at an angle α relative to the body 1810, and comprising opposing members 1823a, 1823b for attaching to structures thereby holding the electronic device in a usable position. It will be appreciated that, in an implementation, the angle α may be between a range of about 50° and about 80°, or in another implementation between about 60° and 70°, or in another implementation about 65°. In the implementation, the attachment flap 1815 may comprise two complementary magnets 1825a, 1825b disposed in the opposing members 1823a, 1823b. The attachment flap 1815 may comprise a fold zone 1830 so that the complementary magnets 1825a, 1825b may interact with each other. In an implementation, the magnets may be about 1.5 inches in width and about 2 inches in length. The thickness may be about 2.5 mm (or about 0.10 inches) and the combined magnetic strength will be equal to or greater than 20,000 Gauss.

An implementation of the holder may comprise an angle α of the attachment flap is from the range of 0 degrees to 90 degrees relative to the body 1810.

An implementation of the holder may comprise an angle α of the attachment flap is from the range of 5 degrees to 80 degrees.

An implementation of the holder may comprise an angle α of the attachment flap that is 40 degrees relative to the body.

An implementation of the holder may be configured wherein the first and second portions of the body are substantially covered by a material that will protect the electronic device surfaces.

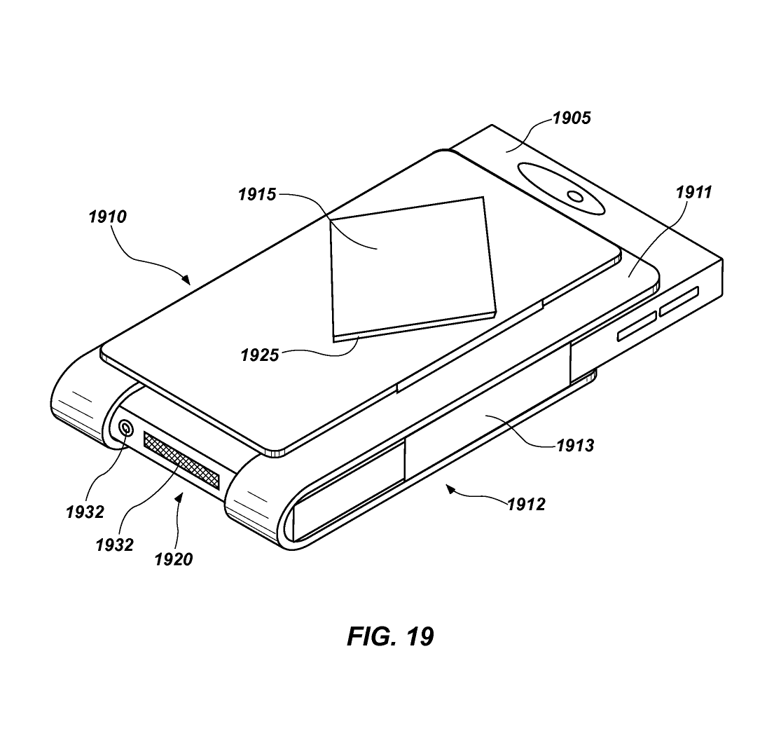

Illustrated in FIG. 19 is an implementation of a hands-free electronics holder holding an electronic device 1905 in a usable position while performing tasks that require the use of a user's hands. The implementation may comprise a substantially rigid body 1910 comprising a first portion 1912 and a second portion 1911 wherein the first portion 1912 may be configured to interface with the electronic device 1905 and wherein the second portion 1911 is configured to also interface with a second electronic device 1905 portion. The body 1910 may be made of any substantially rigid material such as, for example, paperboard or plastic board or any other substantially rigid material without departing from the scope of the disclosure. For example, about 1.6 mm (or about 0.629 inch) paperboard may be used or about 0.5 mm (or about 0.196 inch) plastic board may be used. The implementation may further comprise an opening 1920 for allowing access to and use of inputs/outputs 1932 of an electronic device. It should be understood that the opening may be located anywhere about the holder such that devices having various configurations of inputs and outputs can be accommodated.

In the implementation a channel (not shown) may be formed within a portion of the body 1910 for accommodating a band 1913 made from an elastic material, which is to be located within the channel of the body 1910. The channel may additionally allow for the elastic band 1913 to slide freely within therein allowing the holder to be biased is different configurations. In an implementation, the band 1913 may be about 2 inches wide and have approximately 100% extension, or may have about 80% to about 120% extension. In an implementation the about 2 inch elastic band 1913 may be about 10.6 cm long (or 4.18 inches) and may be secured permanently to the body 1910 at opposing ends.

Additionally, the implementation may comprise an attachment flap 1915 disposed at an angle relative to the body 1910, and may comprise a magnet 1925 disposed thereon. In an implementation, the magnets may be about 1.5 inches in width and about 2 inches in length. The thickness may be about 2.5 mm (or about 0.10 inch) and combined magnetic strength will be equal to or greater than 20,000 Gauss.

The holder may be configured such that the first and second portions of the body are substantially covered by a material that will protect the electronic device surfaces and provide a desired amount of friction.

In the foregoing Detailed Description, various features of the disclosure are grouped together in a single implementation for the purpose of streamlining the disclosure. This method of disclosure is not to be interpreted as reflecting an intention that the claimed disclosure requires more features than are expressly recited in each claim. Rather, inventive aspects lie in less than all features of a single foregoing disclosed implementation.

It is to be understood that the above-described arrangements are only illustrative of the application of the principles of the disclosure. Numerous modifications and alternative arrangements may be devised by those skilled in the art without departing from the spirit and scope of the disclosure and the disclosure is intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

Additionally, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A hands-free apparatus for holding a mobile device, comprising:
a substantially rigid body comprising an upper portion and a lower portion, wherein a pouch is formed between the upper portion and the lower portion that is configured for receiving a mobile device therein, and wherein a channel is formed within the upper portion;
a band made from an elastic material that is located within the channel of the body and is freely slidable within said channel, wherein the band is placed in tension when a mobile device is located within the pouch, thereby holding the mobile device within the pouch; and
a cover member that substantially covers the body and the band to thereby secure the band within the channel.

2. The apparatus of claim 1, wherein the apparatus further comprises a first mechanical closure comprising a structural flap and a foldable joint for attaching the apparatus to an object to thereby position the pouch for receiving the mobile device relative to a user such that the mobile device is useable in a hands-free mode.

3. The apparatus of claim 2, wherein the foldable joint permits the structural flap to move and be oriented into an open and closed position, such that said structural flap is moveable from the open position into the closed position in a single step.

4. The apparatus of claim 1, wherein the body further comprises a plurality of legs.

5. The apparatus of claim 4, wherein an aperture is formed between the plurality of legs, wherein a microphone and a speaker of the mobile device are accessible.

6. The apparatus of claim 2, wherein the structural flap is oriented substantially parallel to the lower portion of the body when said structural flap is in a closed position and comprises at least one magnet to retain the structural flap in the closed position.

7. The apparatus of claim 2, wherein the structural flap is oriented substantially diagonal to the lower portion of the body when said structural flap is in a closed position and comprises at least one magnet to retain the structural flap in the closed position.

8. The apparatus of claim 1, wherein the device is releasably attachable to a safety restraint for use in a vehicle for user safety.

9. The apparatus of claim 2, wherein the apparatus further comprises a substantially rigid flat structure.

10. The apparatus of claim 9, wherein the flat structure comprises a slit or opening formed therethrough.

11. The apparatus of claim 10, wherein the slit or opening receives the flap of the body for connecting the apparatus to the flat structure.

12. The apparatus of claim 11, wherein the structure further comprises one or more connectors for receiving a lanyard or other tethering device.

13. The apparatus of claim 12, wherein the connectors are located at a top portion of the structure and are used connect and hang the flat structure from the lanyard or other tethering device for the convenience of a user.

14. A hands-free electronics holder for holding an electronic device in a usable position while performing tasks require the use of hands comprising:
a substantially rigid body comprising a first portion and a second portion wherein the first portion is configured to interface with a first electronic device portion and wherein the second portion is configured to interface with a second electronic device portion;
an opening for allowing access to inputs/outputs of an electronic device;
a channel formed within the second portion of the body;
a band made from an elastic material that is located within the channel of the body and is freely slidable within said channel, wherein the band is placed in tension when an electronic device is located within the pouch, thereby holding the mobile device within the pouch;
a cover member that substantially covers the body and the band to thereby secure the band within the channel; and
an attachment flap disposed at an angle relative to the body, and comprising opposing members for attaching to structures thereby holding the electronic device in a usable position.

15. The holder of claim 14, wherein the attachment flap comprises two complementary magnets disposed in the opposing members.

16. The holder of claim 14, wherein the angle of the attachment flap is from the range of 0 degrees to 90 degrees.

17. The holder of claim 14, wherein the angle of the attachment flap is from the range of 5 degrees to 80 degrees.

18. The holder of claim 14, wherein the angle of the attachment flap is 40 degrees.

19. The holder of claim 14, wherein said elastic band is substantially permanently attached to the second portion of the body.

20. The holder of claim 14, wherein the first and second portions of the body are substantially covered by a material that will protect the electronic device surfaces.
